(19) United States
(12) Patent Application Publication
(10) Pub. No.: US 2025/0363783 A1
(43) Pub. Date: Nov. 27, 2025

(54) TRAINING IMAGE GENERATION NEURAL NETWORKS TO GENERATE SEMANTICALLY SIMILAR IMAGES

(71) Applicant: GDM Holding LLC, Mountain View, CA (US)

(72) Inventors: Manoj Kumar Sivaraj, Palo Alto, CA (US); Emiel Hoogeboom, Amsterdam (NL); Neil Matthew Tinmouth Houlsby, Zürich (CH)

(21) Appl. No.: 19/216,493

(22) Filed: May 22, 2025

Related U.S. Application Data
(60) Provisional application No. 63/650,809, filed on May 22, 2024.

(51) Int. Cl. G06V 10/774; G06V 10/74; G06V 10/776; G06V 10/82

(52) U.S. Cl. CPC G06V 10/774; G06V 10/761; G06V 10/776; G06V 10/82

(57) ABSTRACT

Methods, systems, and apparatuses, including computer programs encoded on computer storage media, for training an image generation neural network and, once the image generation neural network is trained, generating new output images using the image generation neural network. In particular, the described techniques include obtaining a training data set that includes training examples that each include a training conditioning image and training target image that has been identified to being semantically similar to the training conditioning image. Then training, on the training data set, an image generation neural network that is configured to generate an output image conditioned on a conditioning image. By using the described techniques to train an image generation neural network the system achieves high quality image generation that can be used to generate new output images semantically similar to a conditioning image without the need to fine-tune the image generation neural network to a specific subset of semantic attributes.

### CROSS-REFERENCE TO RELATED APPLICATIONS

This application claims priority of U.S. Provisional Application No. 63/650,809, filed May 22, 2024, the contents of which are incorporated herein by reference in their entirety.

### BACKGROUND

This specification relates to processing images using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers in one or more locations that trains an image generation neural network for use in generating images. Once trained, the system can use the image generation neural network to generate new images.

Particular embodiments of the subject matter described in this specification can be implemented so as to realize one or more of the following advantages.

Generally, image generation neural networks are used to generate images from a broad distribution of images. While such image generation neural networks can perform well with respect to generating images belonging to the broad distribution of images, they may not perform as well generating images belonging to a sub-distribution (e.g., a sub-distribution that represents a set semantic attributes). For example, an image generation neural network may generate images of most animal species in a variety of environments well (i.e., the performance of the image generation neural network in generating images representative of the broad distribution of images is acceptable) but may not perform as well when considering generating specifically images semantically similar to one of a happy dog running in a grassy park on a sunny day exclusively (i.e., the performance of the image generation neural network in generating images representative of the set of semantic attributes included in the image of a happy dog is not acceptable).

Training an image generation neural network to perform well for a sub-distribution of images presents challenges. On the one hand, the image generation neural network must be able to generate variable (or diverse) images within the sub-distribution (within the set of semantic attributes that represents a semantic context), yet it must also be able to generate images that definitively belong to the sub-distribution (the semantic context). One solution is to first train an image generation neural network on a large data set (train on a broad distribution of images) and then later fine tune the image generation neural network on a smaller dataset that is representative of the sub-distribution (semantic context). Unfortunately, such an approach requires careful regularization of the image generation neural network to prevent over-fitting on the smaller data set. Additionally, finetuning for every specific sub-distribution (or semantic context) that the image generation neural network may be used for is computationally expensive (and therefore impractical). Moreover, an appropriately sized data set for finetuning for a specific sub-distribution may not be available for certain sub-distributions.

This specification describes techniques that can address the aforementioned challenges. That is, this specification describes a system that can obtain a training data set that includes a plurality of training examples, where each training example includes (i) a training conditioning image, and (ii) a training target image that has been identified as being semantically similar to the training conditioning image. Then, the system can train on the training data set, an image generation neural network that is configured to generate an output image conditioned on a conditioning image.

By training the image generation neural network using training examples that include a training conditioning image and training target image, the described techniques can generate images based on the semantic context of a conditioning image. Accordingly, there is no need to fine-tune the image generation neural network multiple times for multiple sub-distributions (or semantic contexts).

Additionally, the described techniques include a process of generating a training dataset that includes training examples of training conditioning image-training target image pairs which are filtered pairs of images (based on a similarity score between the images) from the same web page from the internet such that the pair of images are semantically similar.

By using a semantic-based filtering of web-scale image pairs to generate a training data set to train an image generation neural network, the described methods achieve high-quality image generation better than what a conventionally trained image generation neural network achieves.

Furthermore, the described techniques include a process of using a pre-trained conditioning image encoder neural network to generate an encoded representation of the conditioning image, and the encoded representation of the conditioning image serves as a conditioning input for an image generation neural network to generate output images.

By using pre-trained conditioning image encoder neural networks, the described techniques benefit from leveraging the learned representations of the pre-trained conditioning image encoder neural networks. Particularly, the described techniques capture the semantic attributes of a conditioning image well in generated output images in part due to the conditioning on the encoded representation which captures the semantic attributes of the conditioning image.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows an image generation system.

FIG. 2 is a flow diagram of an example process for training an image generation neural network.

FIG. 3 is a flow diagram of an example process for generating a training data set.

FIG. 4 is a flow diagram of an example process for updating trainable parameters of an image generation neural network.

FIG. 5 is a flow diagram of an example process for generating a new image using an image generation neural network.

FIG. 6 is an example of the performance of the described techniques.

FIG. 7 is an example of the performance of the described techniques.

FIG. 8 is an example of the performance of the described techniques.

FIG. 9 is an example of the performance of the described techniques.

### DETAILED DESCRIPTION

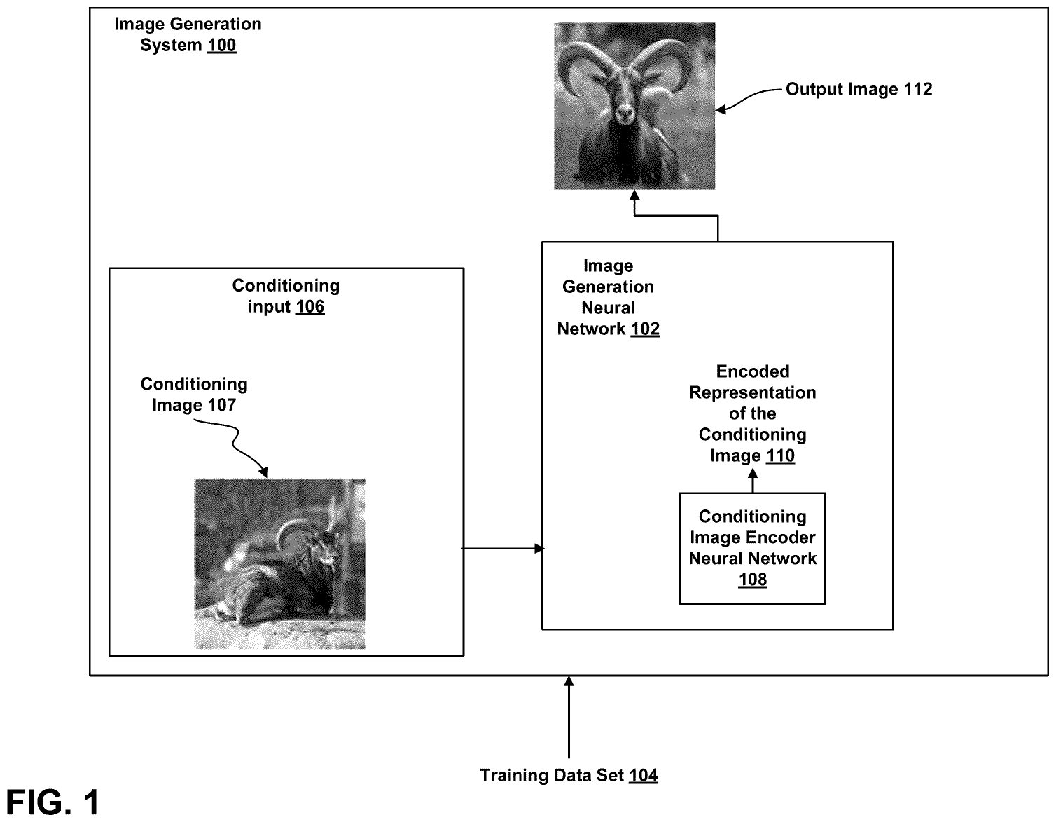

FIG. 1 shows an example image generation system 100. The system 100 is an example of a system implemented as computer programs on one or more computers in one or more locations, in which the systems, components, and techniques described below can be implemented.

The image generation system 100 trains an image generation neural network 102 for use in generating images, and once trained, the system 100 can use the image generation neural network 102 to generate new images.

In particular, the image generation neural network 102 is configured to process a conditioning input 106 that includes a conditioning image 107 to generate an output image 112. The input 106 can also optionally include other data, e.g., a conditioning text sequence, one or more additional conditioning images, a conditioning encoded representation (e.g., a conditioning embedding vector received from an encoder neural network, or a sequence of conditioning embedding vectors received from a language model neural network), and so on.

The image generation neural network 102 can have any appropriate architecture for generating an image 112 conditioned on an input 106 that includes another image 107.

For example, the image generation neural network 102 can be a diffusion neural network that iteratively denoises a representation of the output image 112 conditioned on the conditioning input 106. Examples of such diffusion neural networks include Imagen, simple diffusion, and so on. More generally, the diffusion neural network can perform the denoising process in a latent space or in the pixel space of the generated images.

As a particular example, the image generation neural network 102 can be configured to process the conditioning image 107 using a conditioning image encoder neural network 108 to generate an encoded representation of the conditioning image 110 and to generate the output image 112 conditioned on the encoded representation of the conditioning image 110.

In some cases, the image generation neural network 102 is a neural network that can generate multiple images, e.g., a video that is a sequence of video frames, in response to any given input. That is, in some cases, the image generation neural network 102 is a video generation neural network.

More specifically, the system 100 trains the image generation neural network 102 so that the output image 112 generated by the image generation neural network 102 for a given conditioning image 107 is semantically similar to the given conditioning image 107. That is, the output image 112 has semantics that are similar to the semantics of the given conditioning image 107. In other words, the output image 112 has semantic attributes that are similar to the semantic attributes of the given conditioning image 107. For example, both images can depict images of the same object class or of similar scenes in an environment. This can be done even if the semantics of the conditioning image 107 are not otherwise specified in the conditioning input 106, i.e., there is no text or other input that describes the desired semantics of the output image 112.

In some cases, prior to the system 100 training the image generation neural network 102, the image generation neural network 102 has been pre-trained (e.g., pre-trained on one or more image generation tasks, e.g., a denoising task, a next pixel prediction task, an encoding-decoding image reconstruction task, and so on). In some cases, the pre-training tasks include the use of a conditioning input. In some other cases, the pre-training tasks are unconditional image generation tasks.

For example, the system 100 can train an image generation neural network 102 that is a diffusion neural network that includes a pre-trained denoising neural network pre-trained on a denoising task. The trained denoising neural network of the diffusion neural network can be one configured to receive a noisy initial image and to process the noisy initial image to generate an initial denoising output that defines an estimate of a noise component of the noisy initial image. Ultimately, the diffusion neural network leverages its denoising neural network to iteratively denoise the initial noisy image to generate a final output image. The diffusion neural network can include other components in addition to the denoising neural network, such as a latent space encoder neural network, latent space decoder neural network, upscaling layers, downscaling layers, conditioning input encoder neural network (e.g., the conditioning image encoder neural network 108), and so on. The diffusion neural network can operate either in pixel space (i.e., operate on image pixels) or latent space (i.e., operate on learned compressed representations of images) to generate the output image (i.e., the diffusion neural network denoises a noisy image in pixel space or latent space, and, if denoising occurs in latent space, the system uses a latent space decoder neural network generate the output image 112 in pixel space).

To train the image generation neural network 102, the system 100 obtains a training data set 104 that includes a plurality of training examples, where each training example includes: (i) a training conditioning image, and (ii) a training target image that has been identified as being semantically similar to the training conditioning image.

For example, the training target image may have been identified by the system 100 or by another system as being semantically similar to the training conditioning image by virtue of the target image appearing on the same web page as the training conditioning image. By using shared web page appearances as a signal for semantic similarity, the system 100 or the other system can generate a large, high-quality data set without requiring any semantic labels for images.

The system 100 then trains the image generation neural network 102 on the training data set 104. Generally, the system can train the image generation neural network 102 on the training data set using any appropriate training objective. For example, when the image generation neural network 102 is a diffusion neural network, the system 100 can train the image generation neural network 102 using any appropriate conditional diffusion model training scheme, e.g., on a score matching objective or other diffusion objective.

In some cases, the system 100 has generated the training data set 104 from an initial training data set by filtering one or more of the training examples in the initial training data set based on similarity scores, e.g., inner products, between the images in the training examples.

For example, the system can generate the training data set 104 from an initial training data set of web-scale image pairs and filter one or more training examples based on similarity scores of the web-scale image pairs.

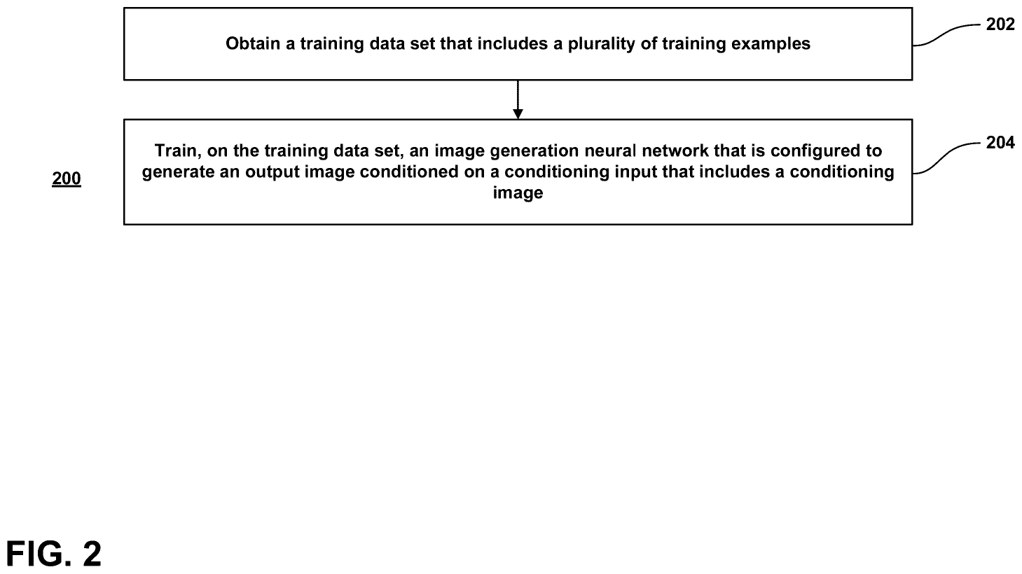

FIG. 2 is a flow diagram of an example process 200 for training an image generation neural network. For convenience, the process 200 will be described as being performed by a system of one or more computers located in one or more locations. For example, an image generation system, e.g., the image generation system 100 of FIG. 1, appropriately programmed in accordance with this specification, can perform the process 200.

The system obtains a training data set that includes a plurality of training examples (step 202). As described above, each training example includes a training conditioning image and a training target image that has been identified as being semantically similar to the training conditioning image.

For example, the system can obtain the data from system-maintained data. As another example, the system can obtain the data from a user or another system through any of a variety of methods, e.g., using a network connection, e.g., a cloud-based network, the internet, or a local network.

The training target image and training conditioning image being semantically similar generally signifies that the images have similar semantic attributes (i.e., attributes associated with the intended meaning of the image). Examples of semantic attributes include an object class (e.g., a car, a dog, a house, etc.), a type of scene in an environment (e.g., a party, a funeral, a classroom), an emotional state (e.g., a determined warrior, an energetic dog, a calm monk, etc.), an action (e.g., crossing a finishing line, dunking a basketball, locking a door, etc.), and so on.

For example, if a training conditioning image is of a goose swimming on a lake, then the semantic attributes can include: object class—goose; type of scene in an environment—a sunny lake; an emotional state—relaxed; and activity—leisurely swimming. Then, additionally, the training target image can share these semantic attributes and depict another goose swimming across a different lake from a different scene perspective.

In some cases, the images of the training examples are from the same internet web pages. Because images from the same web page likely have some common semantic attributes, images from the same web page are a convenient source of semantically similar images. For example, an encyclopedia entry web page for dolphins can include multiple images with the same object class semantic attribute (i.e., dolphins). Thus, in some cases, the training conditioning image and training target image can belong to the same web page. In other words, for some cases, both the training conditioning image and the training target image appear in a particular web page, and the training target image has been identified as being semantically similar to the training conditioning image in response to determining that the training target image and the training conditioning image appear on the particular web page. The system can determine images belong to the same web page by, for example, clustering images according to their URLs (Uniform Resource Locators, i.e., “web addresses”).

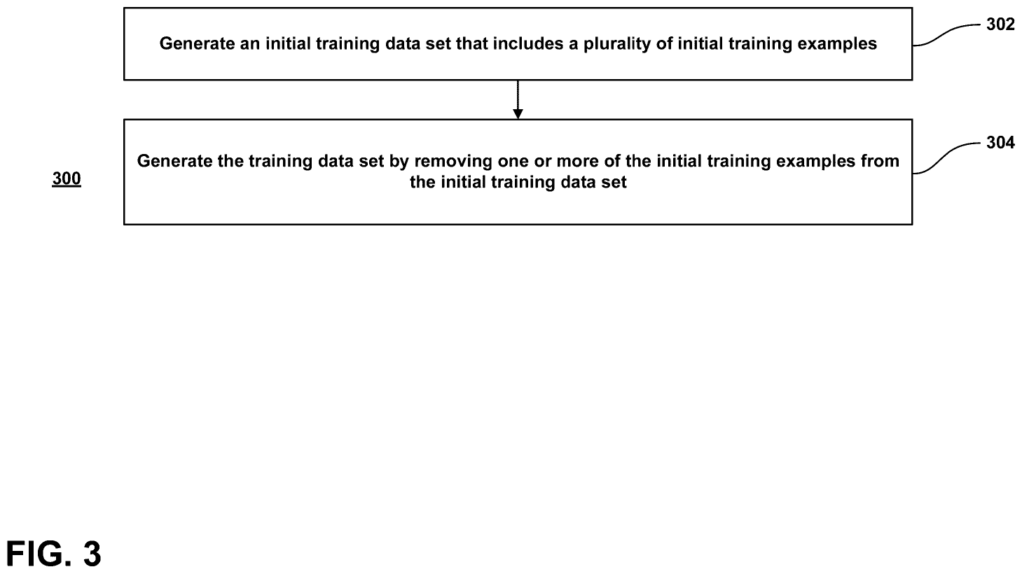

In some cases, the system generates the training data set using an initial data set (e.g., first obtaining an initial data set of training examples that include images from the web pages of the internet, then filtering the training examples based on a metric determined using the training target image and the training conditioning image). Further details of generating a training data set are described below with reference to FIG. 3.

In some cases, some or all of the training conditioning images are composites of two or more original conditioning images.

A composite image is one created by combining images or portions of images. For example, a composite image can be panoramic image of a scene generated by concatenating multiple individual images. As another example, a composite image can be a 3D image generated from multiple cross-sectional images (e.g., an MRI image of patient's torso). So, for example, a training conditioning image that is a composite of two or more original conditioning images can be created by combining two or more images belonging to the same web page that otherwise can be used to generate various training target image and training conditioning image pairs for various training examples. As a particular example, consider a web page advertising a car with multiple images of the same car from various angles. These multiple angle images can be combined to create a composite training conditioning image.

In some cases, each training example further includes a second training conditioning image, and the image generation neural network (described in more detail below) is configured to generate the output image conditioned on the conditioning image and the second conditioning image.

The second conditioning image can be one of similar semantic attributes (e.g., image of the same scene but from a different perspective or time point) or one with different semantic attributes (e.g., an image of a different scene entirely).

In some cases, each training example further includes a training conditioning text sequence, and the image generation neural network (described in more detail below) is configured to generate the output image conditioned on the conditioning image and the conditioning text sequence.

The conditioning text sequence can be any sequence of text. For example, the conditioning text sequence can be a description, a label, a description of visual features to include, a style for the image to take on, effects that are requested to be present in the image, etc. Some examples of sequences of text include “a futuristic hover car flying at night over the city”, or “realistic high-quality 4k photograph of a zebra in a field of tall grass at sunset”.

Generally, the collection of elements the image generation neural network is configured to generate the output image conditioned on are referred to as the conditioning input. In addition to the conditioning image and the optional conditioning text or second conditioning image, the conditioning input can include conditioning audio (e.g., an audio spectrogram or audio waveform), conditioning video (e.g., a sequence of video frames), etc.

Generally, the conditioning input includes the semantic attributes that the system incorporates into the output image, and the system incorporates these semantic attributes into the output image by using the image generation neural network conditioned on the conditioning input to generate the output image.

The system trains, on the training data set, an image generation neural network that is configured to generate an output image conditioned on a conditioning input that includes a conditioning image (step 204).

For instance, after the system obtains the plurality of training examples that each include a training conditioning image and a training target image, the system generates, for each training example, an output image using the conditioning image. Then the system iteratively evaluates a loss function (as is appropriate for the type of image generation neural network) for each training example using the training target image and the output image and updates the trainable parameters of the image generation neural network to minimize the loss function.

The loss function measures how well a generated output matches a target output as is appropriate for the type of image generation neural network. For example, the loss can measure how well the output image matches the training target image, e.g., mean squared error of pixel-space pixel-wise differences between the output image and the training target image. As another example, the loss can measure how well intermediate quantities of the output image match intermediate quantities of the training target image, e.g., for diffusion neural networks the loss can be the mean squared error of an estimated pixel-space pixel-wise (or latent space dimension-wise) noise component of an output image and the actual noise component of the image.

The system continues iteratively evaluating the loss for all training examples and updating the trainable parameters of the image generation neural network until one or more criteria are satisfied (e.g., the system performs a pre-determined number of iterations, the updates to the trainable parameters no longer exceed a pre-determined magnitude of change, a metric regarding a validation dataset exceeds a pre-determined value, and so on).

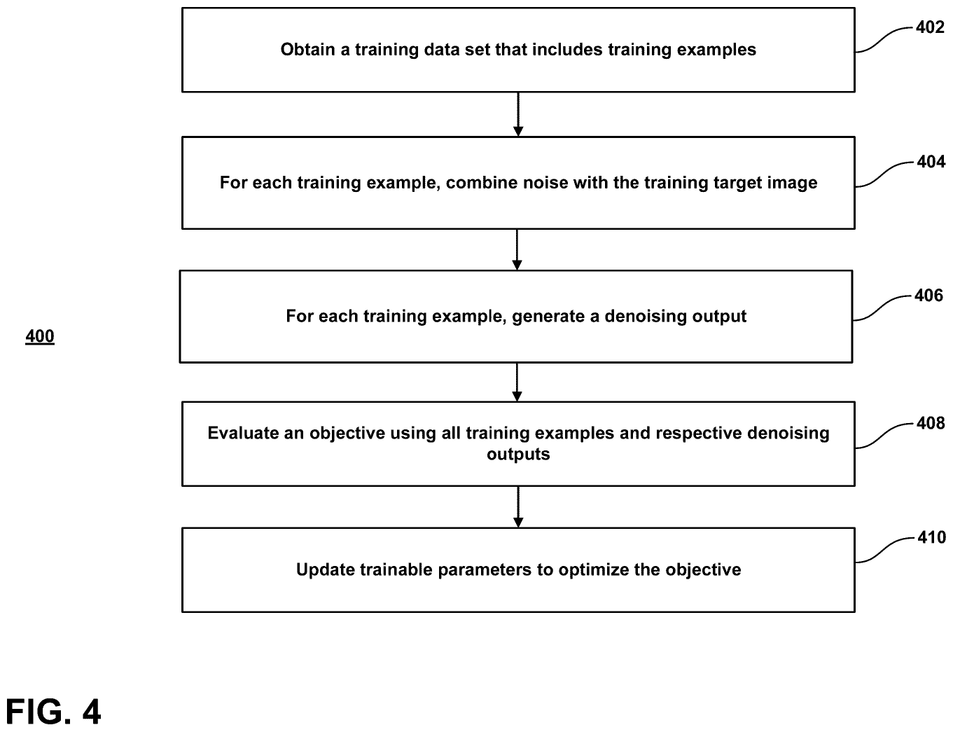

Further details of an example process for updating the trainable parameters of a target denoising neural network are described below with reference to FIG. 4.

The image generation neural network can have any of a variety of neural network architectures. That is, the image generation neural network can have any appropriate architecture in any appropriate configuration such that the image generation neural network can generate an output image conditioned on a conditioning image (or more generally the conditioning input), including fully connected layers, convolutional layers, recurrent layers, attention-based layers, and so on, as is appropriate. Some examples of the image generation neural network are variational auto-encoders, generative adversarial networks, or diffusion neural networks.

When the image generation neural network is a diffusion neural network, in some cases, the system can generate an output image by using the diffusion neural network (i.e., image generation neural network) conditioned on a conditioning image to iteratively denoise a representation of the output image. That is, the system can initialize a representation of an output image by sampling noise values from a noise distribution, then iteratively update the representation of the output image using the diffusion neural network to then generate the output image from the final representation of the output image.

As described above, in some cases, the image generation neural network is a neural network that can generate multiple images, e.g., a video that is a sequence of video frames, in response to any given input. That is, in some cases, the image generation neural network is a video generation neural network.

Some examples of video generation neural networks that the image generation neural network can be follow.

For example, the video generation neural network can be any appropriate neural network that maps a conditioning input to a video that includes multiple video frames that spans a corresponding time window. For example, the video generation neural network can be a diffusion neural network. One example of such a neural network is described in Imagen Video: High Definition Video Generation with Diffusion Models, available at arXiv: 2210.02303. As a particular example of this, the video generation neural network can be a latent diffusion neural network. One example of such a neural network is described in Photorealistic Video Generation with Diffusion Models, available at arXiv: 2312.06662.

As another example, the video generation neural network can be a rectified flow generative neural network. One example of such a neural network is described in Flow Straight and Fast: Learning to Generate and Transfer Data with Rectified Flow, available at arXiv: 2209.03003.

As yet another example, the video generation neural network can be a multistep consistency generative neural network. One example of such a neural network is described in Multistep Consistency Models, available at arXiv: 2403.06807.

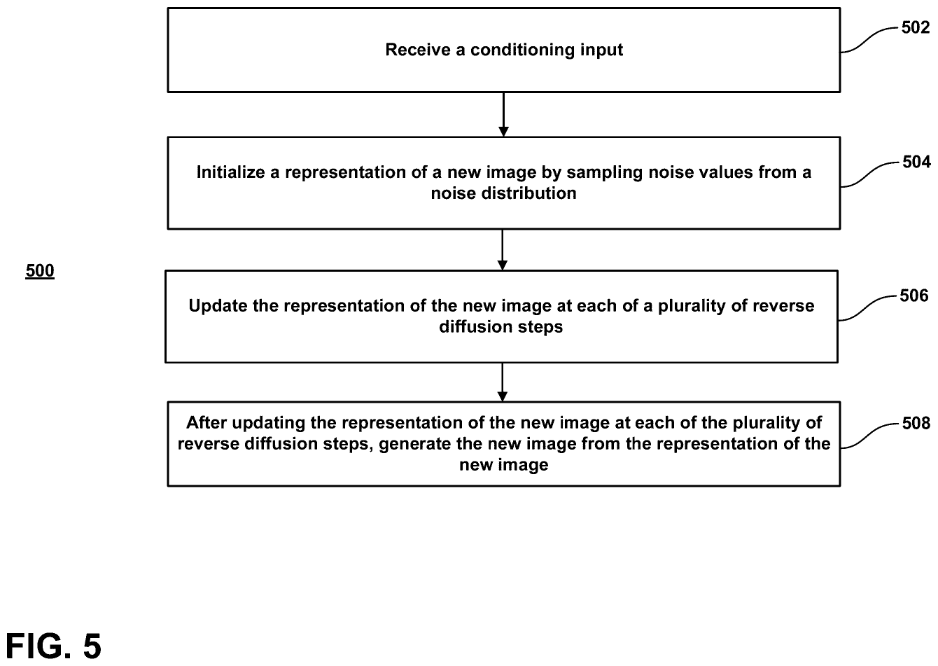

Further details of an example process of generating a new image (e.g., an output image described above) using an image generation neural network are described below with reference to FIG. 5.

In some cases, prior to the system training the image generation neural network, the image generation neural network has been pre-trained on one or more image generation tasks. Some examples of pre-training tasks include generating, reconstructing, denoising, up-scaling, down-scaling, and in-painting images.

In some cases, the image generation neural network is configured to process the conditioning image using a conditioning image encoder neural network to generate an encoded representation of the conditioning image and to generate the output image conditioned on the encoded representation of the conditioning image.

For cases where the image generation neural network includes a conditioning image encoder neural network, the one or more pre-training image generation tasks of the image generation neural network do not necessarily use the conditioning image encoder neural network. In other words, in some implementations, the one or more image generation tasks that the image generation neural network has been pre-trained on are not image-conditional generation tasks. Therefore, in some implementations, the one or more image generation tasks that the image generation neural network was pre-trained on do not use the conditioning image encoder neural network. But, in some other cases, the one or more image generation tasks that the image generation neural was pre-trained on do use the conditioning image encoder neural network.

The conditioning image encoder neural network can have any of a variety of neural network architectures. That is, the conditioning image encoder neural network can have any appropriate architecture in any appropriate configuration that can process a conditioning image to generate an encoded representation of the conditioning image, including fully connected layers, convolutional layers, recurrent layers, attention-based layers, and so on, as is appropriate. As one example, the conditioning image encoder neural networks can be a vision transformer (ViT) based (which includes attention-based layers) neural network or a convolutional neural network or a neural network that includes both attention-based layers and convolutional layers.

The encoded representation can be any of a variety of representation types, and typically, the encoded representation captures the semantic context or semantic attributes of the conditioning image. For example, the encoded representation can be a single numeric vector (e.g., a single vector derived from a classification token as the output of one or more attention-based layers, e.g., the first element of output sequence of a transformer encoder that processes a classification token). As another example, the encoded representation can be a sequence of vectors (e.g., a sequence of vectors or embeddings derived as the output of one or more attention-based layers, e.g., the output sequence of a transformer encoder).

In some cases, the conditioning image encoder neural network has been pre-trained prior to the training of the image generation neural network on the training data set.

For example, in some cases, the conditioning image encoder neural network has been pre-trained on a self-supervised learning task (e.g., instance classification task to distinguish images/patches of images or a knowledge distillation task with no labels as described in arXiv:2104.14294, and so on). In other cases, the conditioning image encoder neural network has been pre-trained on a contrastive learning task (e.g., learning an aligned representation space for images and text using pairwise contrastive loss such as cross-entropy or sigmoid loss).

In some cases, the conditioning image encoder is configured to generate an input sequence of tokens from the conditioning image and to generate an output sequence of tokens representing the conditioning image by processing the input sequence of tokens.

The input sequence of tokens represents the conditioning image, where a token is a fixed sized numeric vector and each token contains information belonging to the conditioning image. Moreover, the output sequence of tokens is a transformation of the input sequence of tokens, so the output sequence of tokens indirectly represents the conditioning image.

For example, the conditioning image encoder can first perform patch embedding (i.e., by decomposing an image into a sequence of patches and then serializing each image patch into a numeric vector. Then, after patch embedding, the system processes the input tokens using the conditioning image encoder to generate output tokens.

In some of these cases, the output sequence of tokens is the encoded representation of the conditioning image. That is, the output sequence of tokens (the output sequence of embeddings or output sequence of numeric vectors) serves as the encoded representation of the conditioning image that the system uses to condition the generation of the output image on.

In some cases, the image generation neural network includes an attention layer configured to apply an attention mechanism to (i) a representation of the output image and (ii) the encoded representation of the conditioning image.

The attention mechanism can be any of a variety of appropriate attention mechanisms, and, generally, the attention mechanism enables the representation of the output image to attend to the most relevant portions of the encoded representation.

For example, the attention mechanism can be cross-attention between (i) the representation of the output image and (ii) the encoded representation.

As a particular example, when the image generation neural network is a diffusion model that includes a denoising neural network to iteratively denoise a representation of the output image, the denoising neural network can be a U-Net neural network or other convolutional neural network (CNN) that includes cross-attention layers that perform the cross attention between the representation of the output image and the encoded representation. That is, an image generation neural network can include a CNN-based U-Net denoising neural network that can receive the encoded representation by mechanisms such as cross attention to facilitate interaction between an intermediate denoised noisy image (i.e., a representation of the output image) and the encoded representation.

As another example, the attention mechanism can be self-attention over (i) the representation of the output image and (ii) the encoded representation.

As a particular example, when the image generation neural network is a diffusion model that includes a denoising neural network to iteratively denoise a representation of the output image, the denoising neural network can be the U-ViT neural network that includes self-attention layers as described in arXiv:2209.12152. That is, an image generation neural network can include a U-ViT denoising neural network that can receive the representation of the output image, the encoded representation, and other optional inputs (e.g., a time variable) as a combined sequence and process the combined sequence using a vision transformer encoder that includes a multi-head attention layer (i.e., a layer that applies the self-attention mechanism multiple times).

In some cases, the conditioning image encoder neural network is held fixed during the training of the image generation neural network on the training data set. That is, the conditioning image encoder neural network does not include trainable parameters that are updated during the training of the image generation neural network. For example, the conditioning image encoder neural network can be the pre-trained CLIP encoder (as described in arXiv: 2103.00020) or pre-trained DINO encoder (as described in arXiv: 2304.07193) without updating the parameters of these neural networks.

After the system trains the image generation neural network on the training data set, the system can generate new output images. That is, the system can receive a new conditioning image, and then the system can process the new conditioning image using the image generation neural network to generate a new output image that is semantically similar to the new conditioning image.

Further details of an example process of generating a new image (e.g., a new output image described above) using an image generation neural network are described below with reference to FIG. 5.

In some implementations, after generating a new output image (e.g., as described above) using the image generation neural network (i.e., a first image generation neural network), the system trains another image generation neural network (i.e., a second image generation neural network) on a new training data set that includes the new output image.

For example, the system can train the other image generation neural network (i.e., the second image generation neural network) on an augmented data set that includes one or more new output images generated using the first image generation neural network.

The system can train the other image generation neural network for any of a variety of purposes.

For example, the system can train the other image generation neural network with the purpose of performing “domain transfer” (i.e., to train the second image generation neural network to adapt to distribution of images represented by the new output images generated by the first image generation neural network).

As another example, the system can train the other image generation neural network with the purpose of performing “distillation” (i.e., to train the, in this case, smaller second image generation neural network (i.e., smaller memory footprint than the first image generation neural network) to generate outputs similar to those of the first image generation neural network.

In some implementations, after generating a new output image (e.g., as described above), the system uses the new output image and the new conditioning image to evaluate an image encoder neural network. For example, the system can process both the semantically similar new output image and the new conditioning image using the image encoder neural network to generate respective encoded representations of these images, and because an image encoder that performs well generates similar encoded representations of images for semantically similar images, the system can evaluate the image encoder neural network by determining how high a similarity score (e.g., cosine similarity score) between the encoded representations is. A high similarity score would indicate a high performing image encoder neural network, while a low similarity score would indicate a poor performing image encoder neural network.

FIG. 3 is a flow diagram of an example process 300 for generating a training data set. For convenience, the process 300 will be described as being performed by a system of one or more computers located in one or more locations. For example, an image generation system, e.g., the image generation system 100 of FIG. 1, appropriately programmed in accordance with this specification, can perform the process 300.

The system generates an initial training data set that includes a plurality of initial training examples (step 302).

In some cases, to generate the initial training examples, the system, for each initial training example, identifies a plurality of images that each appear on a same corresponding web page. Then, the system identifies, as the training conditioning image in the initial training example, a first image from the plurality of images that appear on the corresponding web page. Next, the system identifies, as the training target image in the initial training example, a second, different image from the plurality of images that appear on the corresponding web page.

To identify a plurality of images that each appear on the same corresponding web page, the system can, e.g., randomly sample loosely related images grouped according to their URLs or group all related images according to their URLs.

In some cases, the system identifies the first image by randomly selecting the first image from the images on the corresponding web page. For example, randomly selecting an image from images grouped according to a web page URL.

Further in some cases, the system identifies the second image by randomly selecting the second image from the images on the corresponding web page other than the first image. For example, randomly selecting an image from images grouped according to web page URL after selecting the first image without replacement from the same group.

The system generates the training data set by removing one or more of the initial training examples from the initial training data set (step 304).

In some implementations, to remove one or more of the initial training examples from the initial training data set, the system, for each initial training example, processes the training conditioning image in the initial training example using an image encoder neural network to generate an image embedding of the training conditioning image. The system then processes the training target image in the initial training example using the image encoder neural network to generate an image embedding of the training target image. Then the system determines a similarity score between the image embedding of the training conditioning image and the image embedding of the training target image.

The image encoder neural network can have any of a variety of neural network architectures. That is, the image encoder neural network can have any appropriate architecture in any appropriate configuration that can process a training conditioning image to generate an image embedding of the training conditioning image and can process a training target image to generating an image embedding of the training target image, including fully connected layers, convolutional layers, recurrent layers, attention-based layers, and so on, as is appropriate.

As one example, the conditioning image encoder neural networks can be a vision transformer (ViT) based neural network, which includes attention-based layers. The system can decompose an input image that this image encoder neural network processes into patches that are subsequently serialized into a sequence of input tokens (or a sequence of numeric vectors) and prepend this sequence of input tokens with a special classification token (or CLS token). The system can then process this sequence of input tokens using the ViT image encoder to generate a sequence of output tokens (with a one-to-one correspondence to the input tokens) and designate the output token corresponding to the classification token as the image embedding of the input image.

While in some cases the conditioning image encoder neural network and the image encoder neural network are not the same, in some other cases, the conditioning image encoder neural network and the image encoder neural network are the same.

The similarity score can be any of a variety of types of similarity scores. For example, the similarity score can be the cosine similarity between the image embedding of the training conditioning input image and the training target image. Other examples of similarity scores are dot-product and Euclidean distance.

In some implementations, to remove one or more of the initial training examples from the initial training data set, the system removes one or more initial training examples based on the similarity score between the image embedding of the training conditioning image in the initial training example and the image embedding of the training target image in the initial training example being above a first threshold similarity score. Removing initial training examples with respective similarity scores above a first threshold similarity score that is high ensures that the training examples each have a training conditioning image and a training target image that are distinct, encouraging the trained image generation neural network to generate outputs that share semantic attributes with a conditioning image rather than replicating the conditioning image.

For example, for a similarity score that ranges from −1 to +1 (e.g., the cosine similarity scores), the system can remove initial training examples that result in a similarity score above a first threshold value of 0.9, 0.99, or 0.999.

Further in some implementations, to remove one or more of the initial training examples from the initial training data set, the system removes one or more initial training examples based on the similarity score between the image embedding of the training conditioning image in the initial training example and the image embedding of the training target image in the initial training example being below a second threshold similarity score. Removing initial training examples with respective similarity scores below a second threshold similarity score that is low ensures that the training examples each have a training conditioning image and a training target image that share some semantic attributes, encouraging the trained image generation neural network to generate outputs that share semantic attributes with a conditioning image rather than generating a completely unrelated image.

For example, for a similarity score that ranges from −1 to +1 (e.g., the cosine similarity scores), the system can remove initial training examples that result in a similarity score below a second threshold similarity score of 0.3, 0.03, or 0.003.

FIG. 4 is a flow diagram of an example process 400 for updating trainable parameters of an image generation neural network. For convenience, the process 400 will be described as being performed by a system of one or more computers located in one or more locations. For example, an image generation system, e.g., the image generation system 100 of FIG. 1, appropriately programmed in accordance with this specification, can perform the process 400.

In particular, example process 400 describes training the image generation neural network when the neural network is a diffusion neural network conditioned on conditioning input and that uses a DDPM (denoising diffusion probabilistic model) sampler to generate output images. That is, the image generation neural network of example process 400 iteratively denoises an initial noisy representation of an output image by predicting and removing the noise component of the noisy representation of the output image to generate the output image as the final noiseless output image, all while conditioned on a conditioning input (which includes at least a conditioning image).

Further details of an example process of generating an image using an image generation neural network that is a diffusion neural network that uses a DDPM sampler are described below with reference to FIG. 5.

The system or another training system repeatedly updates the trainable parameters of the image generation neural network using a training data set, e.g., filtered web-scale image pairs as described above. That is, the system can repeatedly perform the following described example process using training examples to repeatedly update all or a subset of the trainable parameters of the image generation neural network from scratch, i.e., train from randomly initialized parameters, or to fine-tune, i.e., further update previously determined parameters, e.g., pre-trained parameters.

For example, the image generation neural network may or may not have been pre-trained, in which case the system may respectively train the image generation neural network from scratch or fine-tune the image generation neural network.

As another example, when the image generation neural network includes a conditioning image encoder neural network, the conditioning image encoder neural network may or may not have been pre-trained, in which case the system may respectively train the conditioning image encoder neural network from scratch (for the case that the conditioning image encoder neural network is not a pre-trained neural network), or fine-tune or not train the conditioning image encoder neural network (for the case that the conditioning image encoder neural network is a pre-trained neural network).

The system obtains a training data set that includes training examples (step 402). As described above, the system can obtain the training data from system-maintained data, a user, or another system through any of a variety of methods.

As described above, the training data includes a plurality of training examples, and each training example includes a respective training conditioning image and a training target image that has been identified as being semantically similar to the training conditioning image.

The system, for each training example, combines noise with the training target image (step 404). The result is a noisy training target image. The system can determine the noise and combine the noise with the training target image to generate the noisy training target image using any of a variety of methods.

For example, the system can sample noise from a noise distribution, e.g., probability distribution, e.g., a Gaussian probability distribution, with the same number of dimensions as the number of pixels included in the training target image (i.e., the number dimensions of the training target image) and elementwise sum the sampled noise with the pixel values of the training target image to generate the noisy training target image.

In some cases, the system can determine the noise according to one or more time steps, particularly when time steps define noise levels for corresponding noisy images.

For example, the system can use a Markovian process to generate a noisy training target image, e.g., the forward process of DDPM. That is, given a training target image, a number of diffusion steps (i.e., time steps), and a variance schedule across diffusion steps, the system can generate the noisy training target image by drawing samples for parameterized normal distributions.

For example, the recursive equation

$$N ( {x}_{t} ; \sqrt{1 - {β}_{t}} {x}_{t - 1} , {β}_{t} \cdot I ) , ∀ t ∈ 1 , … , T$$

represents how the system can generate the noisy training target image xₜ associated with time step t by repeatedly sampling parameterized Gaussians, where T is the number of diffusion steps, β₁, . . . , β_{T}∈[0,1) are the variance schedule values across diffusion steps, I is the identity matrix having the same dimensions as the input image x₀, \sqrt{1−βₜ}xₜ₋₁ is the scaled noisy training target image of a previous diffusion step, and N (x; μ,σ) represents the normal distribution of mean μ and covariance σ that produces x.

As another example, the equation

$${x}_{t} = \sqrt{{\underline{α}}_{t}} {x}_{0} + \sqrt{1 - {\underline{α}}_{t}} ϵ$$

also represents how the system can generate the noisy training target image xₜ, where ϵ is noise sampled from a Gaussian distribution, i.e., ϵ˜N(0,1), and

$${\underline{α}}_{t} = {\prod }_{s = 1}^{t} ( 1 - {β}_{s} ) .$$

Moreover, the system can combine one or more different noises with the same training target image to generate one or more respective noisy training target images. For example, considering the previous example of generating a noisy training target image by sampling ϵ, the system can sample one or more values of ϵ for the same time step t, for one or more time steps, or both, to generate one or more noisy training target images.

The system, for each training example, generates a denoising output (step 406).

In other words, for each noisy training target image generated during step 404, the system uses the image generation neural network (which in this case is the diffusion neural network which in turn includes a denoising neural network) to process at least the noisy training target image to generate a denoising output that defines an estimate of a noise component of the noisy training target image.

For cases that the system uses a time step to generate the noisy training target image from the training target image of the training example, the system can use the image generation neural network to generate the denoising output that additionally processes at least the respective time step of the noisy training target image.

As described above, in some cases, each training example further includes a respective training conditioning input that characterizes one or more semantic attributes of the respective target training image in the training example. For such cases, the system can use the image generation neural network to generate the denoising output that additionally processes at least the conditioning input.

For example, the system uses the denoising neural network of the image generation neural network conditioned on the training conditioning image to process at least the noisy training target image to generate a denoising output that defines an estimate of a noise component of the noisy training target image.

The system evaluates an objective using all training examples and respective denoising outputs (step 408).

Generally, the objective evaluates the performance of the denoising outputs the system produces using the diffusion neural network during step 406. For example, the objective (or objective function) can include a loss for each training example. For example, the objective can be represented as the equation

$${E}_{{x}_{0} ∼ q ( {x}_{0} ) , ϵ ∼ N ( 0 , 1 ) , t ∼ U ( 1 , T )} [ {‖ ϵ - {ϵ}_{θ} ( \sqrt{{\underline{α}}_{t}} {x}_{0} + \sqrt{1 - {\underline{α}}_{t}} ϵ , t , c ) ‖}^{2} ]$$

where E denotes an expectation over training target images (i.e., x₀˜q(x₀), where q(x₀) represents the probability of sampling the training target image x₀ according to the training data set), over sampled noise (i.e., ϵ˜N(0,1)), over time steps (i.e., t˜U(1,T), where U(1,T) denotes a uniform distribution of time steps from 1 to T). Additionally, the term \sqrt{αₜ}+\sqrt{1−αₜ}ϵ is the noisy training target image (as described in an example above), c is the conditioning input, and the term ϵ_{θ}(·) refers to the estimate of the noise component of the noisy training target image generated by the image generation neural network.

In some cases, the objective includes one or more regularization terms that penalizes higher values for the trainable parameters to reduce the risk of the trainable parameters of the image generation neural network (especially the denoising neural network belonging to the image generation neural network) overfitting the training data. For example, the regularization terms can include the LP regularization term λ∥w∥ₚ^{p}, where λ is the regularization parameter, w is the vector of trainable parameters, and p is the norm degree (e.g., p=1 for L1 regularization, p=2 for L2 regularization).

The system, updates trainable parameters to optimize the objective (step 410).

The system can update the trainable parameters of the image generation neural network to optimize the objective in any variety of ways, e.g., gradient based method, evolutionary algorithm-based method, Bayesian optimization, etc.

For example, the system can optimize the objective using any of a variety of gradient descent techniques (e.g., batch gradient descent, stochastic gradient descent, or mini-batch gradient descent) that include the use of a backpropagation technique to estimate the gradient of the loss with respect to trainable parameters of the neural network and to update the learnable parameters accordingly.

Generally, the system repeats the above steps until one or more criteria are satisfied (e.g., the system performs a pre-determined number of iterations, the updates to the trainable parameters no longer exceed a pre-determined magnitude of change, a metric regarding a validation dataset exceeds a pre-determined value, and so on).

FIG. 5 is a flow diagram of an example process 500 for generating a new image using an image generation neural network. For convenience, the process 500 will be described as being performed by a system of one or more computers located in one or more locations. For example, an image generation system, e.g., the image generation system 100 of FIG. 1, appropriately programmed in accordance with this specification, can perform the process 500.

The system receives a conditioning input (step 502). As described above, generally, the conditioning input includes at least a conditioning image and contains the semantic attributes that will be included in the new image. Additional examples of conditioning elements that the conditioning input can include are encodings of a text sequence, another image, audio data, video data, and so on.

As described above, in some cases, the image generation neural network includes a conditioning image encoder neural network to generate an encoded representation of the conditioning image.

For cases that the conditioning input includes other conditioning elements, the image generation neural network can include respective encoders for those elements. For example, for cases that the conditioning input includes a text sequence, the system can process the text sequence using a text encoder neural network to generate a respective encoded representation of the text sequence.

In some cases, when the conditioning input includes multiple conditioning elements that are processed by respective conditioning element encoders, the system can combine the respective encoded representations of the conditioning elements to generate a combined encoded representation. For example, the system can generate a combined encoded representation by concatenating the encoded representations of the conditioning input elements to generate a concatenated encoded representation.

In example 500, each reverse diffusion step (described below) is conditioned on the conditioning input (and, if the system processes the conditioning input to generate encoded representations, then each reverse diffusion step is conditioned on the encoded representations).

The system initializes a representation of a new image by sampling noise values from a noise distribution (step 504). In other words, the system sets the pixel values of a representation of a new image using noise values of sampled noise, where each dimension of the sampled noise represents a pixel value. The system can draw the sampled noise values from any of a variety of probability distributions, e.g., a multivariate Gaussian with isotropic covariance.

The system updates the representation of the new image at each of a plurality of reverse diffusion steps (step 506). In particular, the system processes a denoising input for the reverse diffusion step that includes the representation of the new image using a denoising neural network (a subcomponent of the diffusion neural network, i.e., the image generation neural network) conditioned on the conditioning input to generate a denoising output that defines an estimate of a noise component of the representation of the new image. The system then updates the representation of the new image using the denoising output.

For example, for a given diffusion step, when the system applies the DDPM diffusion sampler, the system can subtract the estimate of the noise component of the representation of the new image from the representation of the new image (e.g., an elementwise subtraction of estimated noise values of the estimated noise component from pixel values of the representation of the new image), and optionally can add back in a small amount of noise. The result is the updated representation of the new image.

As another example, for a given diffusion step, when the system applies the DDIM diffusion sampler, the system can determine an initial estimate of the final representation of the new image using the representation of the new image for the current diffusion step. The system then can generate the updated representation of the new image using the initial estimate of the final representation of the new image and the representation of the new image of the current diffusion step. The result is the updated representation of the new image.

After generation, the updated representation of the new image can be included in the denoising input of the subsequent diffusion step as the representation of the new image.

The system, in some cases, uses classifier-free guidance at each reverse diffusion step. When using classifier-free guidance, the system processes the denoising input for the reverse diffusion step that includes the representation of the new image using the denoising neural network but not conditioned on the conditioning input to generate another denoising output. The system then combines the conditional and unconditional denoising outputs in accordance with a guidance weight for the reverse diffusion step to generate a final denoising output.

For example, the following equation

$${ϵ}_{θ}^{∼} ( {x}_{t} , c ) = ( 1 + w ) {ϵ}_{θ} ( {x}_{t} , c ) - w {ϵ}_{θ} ( {x}_{t} )$$

represents how the system can use classifier-free guidance at each reverse diffusion step, where the term ϵ^{˜}_{θ}(xₜ,c) denotes the final denoising output, w the guidance factor, xₜ the representation of the new image, c the conditioning input, and ϵ_{θ}(xₜ,c) the conditional denoising output and ϵ_{θ}(xₜ) the unconditional denoising output.

Generally, the system performs a pre-determined number of the of reverse diffusion steps set by a user, the system, or another system. For example, the system can receive the number of reverse diffusion steps from a user.

In some cases, the denoising input for the reverse diffusion step includes a respective time input. For such cases, the system can determine the number of reverse diffusion steps to be, e.g., aligned with the number of timesteps used to train the denoising neural network, e.g., aligned with the number of time steps sampled to generate noisy target images from a target image as described above with respect to training an image generation neural network that is a diffusion neural network in example 400.

The system, after updating the representation of the new image at each of the plurality of reverse diffusion steps, generates the new image from the representation of the new image (step 508).

In some implementations, when the representation of the new image is in pixel space, the system outputs, as the new image, the representation of the new image after being updated at each of the plurality of reverse diffusion steps. In other words, the system outputs as the new image the most recently updated representation of the new image.

In other implementations, when the representation of the new image is in latent space, the system outputs, as the new image, the decoded representation of the new image (using a decoder neural network that is included in the image generation neural network) after being updated at each of the plurality of reverse diffusion steps.

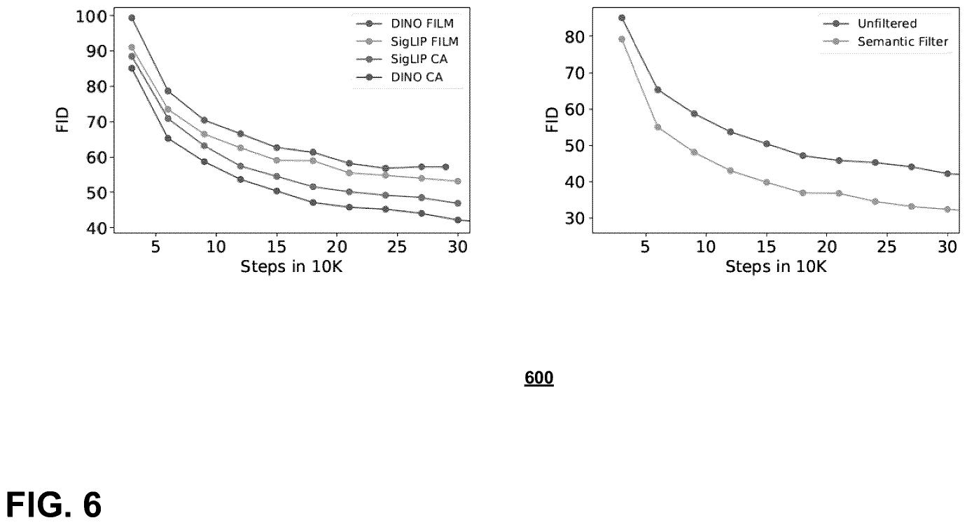

FIG. 6 is an example 600 of the performance of the described techniques.

In particular, example 600 shows two plots of the FID metric for the ImageNet image data set (i.e., an image distribution metric that measures how similar generated images are to images of the ImageNet dataset; lower FID values indicate better performance) using generated images for various choices of aspects of the described techniques as a function of number of training iterations (i.e., “steps”) the system trains an image generation neural network using the Episodic WebLI training data set.

The left plot shows FID for two different choices of conditioning image encoder neural networks (i.e., DINO B/14 and SigLIP B/16) for which the image generation neural network is conditioned on a conditioning input using two different conditioning methods (i.e., (1) all encoder output tokens via cross-attention (CA) and (2) global feature representation via FiLM (Feature-wise Linear Modulation) layers).

The right plot shows FID of DINO B/14+Cross Attention with and without “semantic filtering” (i.e., removing initial training examples of an initial data set that is the WebLI training data using a first and second threshold and similarity score for each initial training example, as described above).

Example 600 left plot shows that token-level conditioning significantly outperforms global feature conditioning for both DINO and SigLIP, highlighting the importance of low-level features. While SigLIP FiLM performs better than DINO FILM, this trend reverses with cross-attention. This suggests a greater compatibility of DINO low-level features over CLIP low-level features for semantics-based image generation.

Also, example 600 right plot shows that “semantic filtering” (i.e., removing initial training examples of an initial data set that is the WebLI training data using a first and second threshold and similarity score for each initial training example, as described above) is responsible for a certain amount of performance advantage of the described techniques. Example 600 shows that “semantic filtering” in DINO feature space positively impacts the generation quality of the image generation neural network and improves FID by greater than 10.

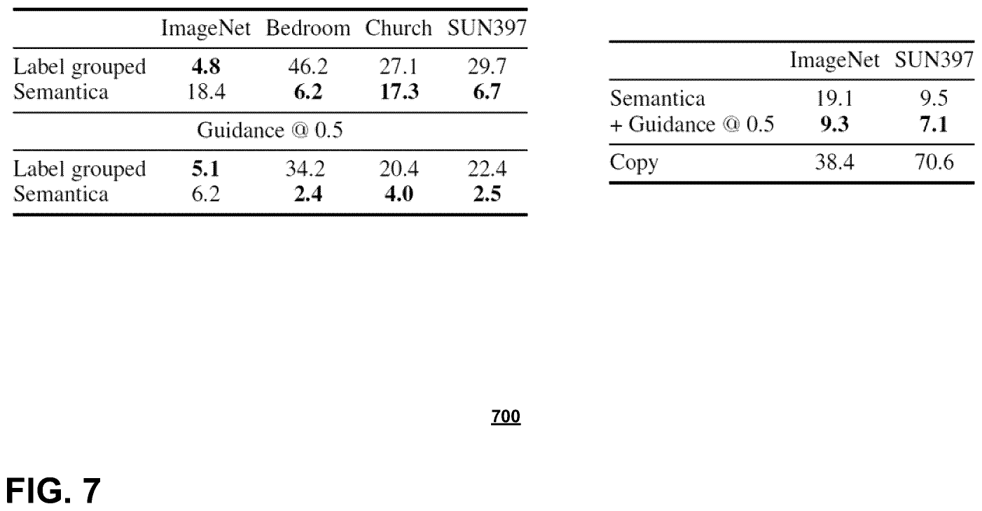

FIG. 7 is an example 700 of the performance of the described techniques.

In particular, example 700 shows two tables. The left table compares the performance of the described techniques denoted as “Semantica” to a baseline denoted as “Label grouped” (where “Label grouped” ablates an aspect of the described techniques) in terms of the FID metric for four different data sets (i.e., the image data sets labeled as ImageNet, Bedroom, Church, and SUN39). The “Label grouped” baseline refers to training an image generation neural network using a training data set that includes training examples that each include a training conditioning image and training target images of the same object class as per their labels from the ImageNet image data set. “Semantica” trains an image generation neural network using randomly sampled loosely related images from the internet grouped according to their URLs to determine the training conditioning image and training target image, as described above.

The left table of example 700 shows that “Label grouped” outperforms “Semantica” on the ImageNet data set because the image generation neural network belonging to “Label grouped” trains using the dataset of ImageNet. However, for all other datasets, “Semantica” outperforms “Label grouped” showing that “Semantica” performs better on “out-of-distribution” data sets (relative to the ImageNet data set).

The right table compares the described techniques when new image generation includes the use of “guidance” (i.e., the row labeled as “+Guidance @ 0.5,i.e., generating images using classifier free guidance with a guidance factor of 0.5, e.g., as described above with reference to FIG. 5) to when it does not (i.e., the row labeled as “Semantica”) in terms of the FID metric for the ImageNet and SUN397 image data sets. Specifically, the FID is calculated using an image generation neural network that receives 1000 and 397 conditioning images for ImageNet and SUN397 respectively, one-per-class, and generates 50 and 120 new output images per-class for ImageNet and SUN397. Then the FID is calculated using 50000 ground images. The reported baseline (the last row labeled as “Copy”) reports the FID as a result of 50 and 120 copies of the conditioning images (instead of new output images) per class. The described techniques achieve FID values lower than “Copy” which implies that the described techniques generate new output images that are not just copies of the conditioning input. Additionally, the described techniques without guidance achieves a FID of 19.1 and 9.5 on ImageNet and SUN397, respectively. But the described techniques with the additional use of “+Guidance @ 0.5” yields an improved of 9.3 and 7.1, respectively.

The tables of example 700 shows that the described techniques' training improve the FID performance of an image generation neural network (as shown in the left table as “Semantica” outperforming “Label grouped”) and is responsible for generating output images that are semantically similar to a conditioning image without being a copy of the conditioning image (as shown in the right table as “Semantica”/“+Guidance @ 0.5” outperforming “copy”).

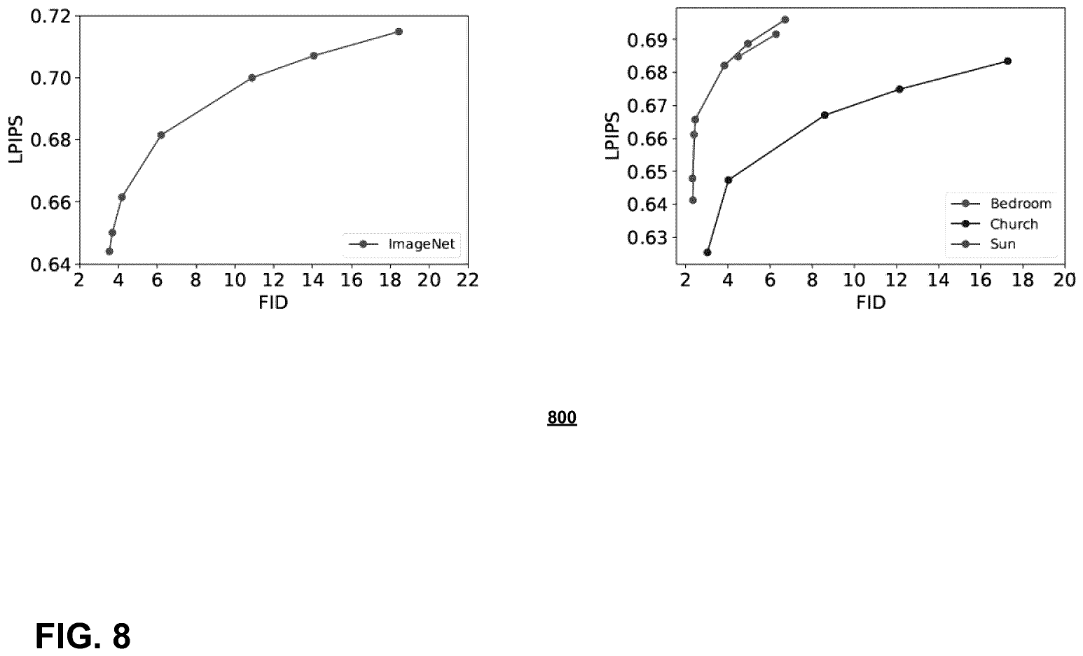

FIG. 8 is an example 800 of the performance of the described techniques.

In particular, example 800 shows two plots of LPIPS (learned perceptual image patch similarity, which is defined as the distance between image patches; higher is more diverse) vs FID for four different image data sets (ImageNet, Bedroom, Church, SUN397) where each point within each plot is the result of using a different guidance factor value to generate images with the image generation neural network.

Example 800 shows that even when the guidance factor is increased to a high degree (points towards the right of the plots) the generated output images of the described techniques do not collapse completely to their respective conditioning images. As a result, the described techniques can generate diverse output images while being semantically similar to the conditioning image.

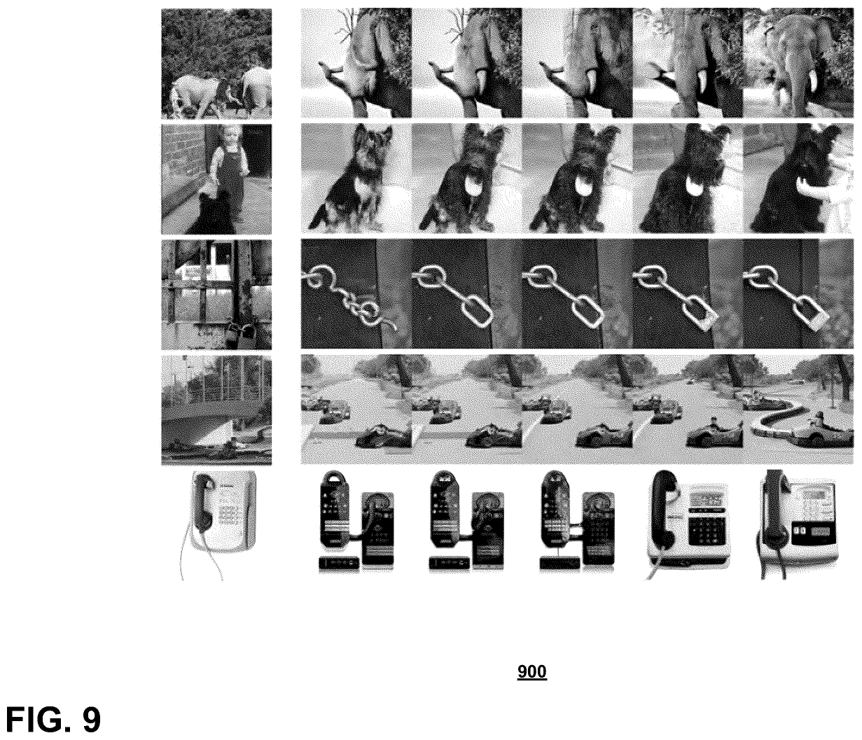

FIG. 9 is an example 900 of the performance of the described techniques.

In particular, example 900 showcases conditioning images (leftmost column) and their respective output images generated using an image generation neural network with varying guidance factors (within the same row as the conditioning input with increasing guidance factors used from left to right).

Example 900 shows that the described techniques can control the degree of semantic similarity of the output images to the conditioning image through an increase of the guidance factor. For example, consider the row of images that includes the conditioning image that contains a child and a dog. The left most output image shares some semantic attributes because both contain a dog with someone standing behind the dog. But the far right output image shares more semantic attributes with the conditioning image because the dog is a similar species to the dog of the conditioning image and the output image also contains a child with a background of a brick wall.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of Al and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small, embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a training data set comprising a plurality of training examples, each training example comprising:
(i) a training conditioning image, and
(ii) a training target image that has been identified as being semantically similar to the training conditioning image; and
training, on the training data set, an image generation neural network that is configured to generate an output image conditioned on a conditioning image.

2. The method of claim 1, wherein prior to the training, the image generation neural network has been pre-trained on one or more image generation tasks.

3. The method of claim 1, wherein the image generation neural network is a diffusion neural network.

4. The method of claim 1, wherein, for each training example:
the training conditioning image appears in a particular web page;
the training target image also appears on the particular web page; and
the training target image has been identified as being semantically similar to the training conditioning image in response to determining that the training target image and the training conditioning image appear on the particular web page.

5. The method of claim 1, further comprising:
generating an initial training data set, the initial training data set comprising a plurality of initial training examples; and
generating the training data set by removing one or more of the initial training examples from the initial training data set.

6. The method of claim 5, wherein generating the initial training data set comprises, for each initial training example:
identifying a plurality of images that each appear on a same corresponding web page;
identifying, as the training conditioning image in the initial training example, a first image from the plurality of images that appear on the corresponding web page; and
identifying, as the training target image in the initial training example, a second, different image from the plurality of images that appear on the corresponding web page.

7. The method of claim 6, wherein identifying the first image comprises:
randomly selecting the first image from the images on the corresponding web page.

8. The method of claim 7, wherein identifying the second image comprises:
randomly selecting the second image from the images on the corresponding web page other than the first image.

9. The method of claim 5, wherein removing one or more of the initial training examples from the initial training data set comprises:
for each initial training example:
processing the training conditioning image in the initial training example using an image encoder neural network to generate an image embedding of the training conditioning image,
processing the training target image in the initial training example using the image encoder neural network to generate an image embedding of the training target image, and
determining a similarity score between the image embedding of the training conditioning image and the image embedding of the training target image.

10. The method of claim 9, wherein removing one or more of the initial training examples from the initial training data set comprises:
removing one or more initial training examples based on the similarity score between the image embedding of the training conditioning image in the initial training example and the image embedding of the training target image in the initial training example being above a first threshold similarity score.

11. The method of claim 9, wherein removing one or more of the initial training examples from the initial training data set comprises:
removing one or more initial training examples based on the similarity score between the image embedding of the training conditioning image in the initial training example and the image embedding of the training target image in the initial training example being below a second threshold similarity score.

12. The method of claim 1, wherein the image generation neural network is configured to process the conditioning image using a conditioning image encoder neural network to generate an encoded representation of the conditioning image and to generate the output image conditioned on the encoded representation of the conditioning image.

13. The method of claim 12, wherein the conditioning image encoder neural network has been pre-trained prior to the training of the image generation neural network on the training data set.

14. The method of claim 13, wherein the conditioning image encoder neural network is held fixed during the training of the image generation neural network on the training data set.

15. The method of claim 13, wherein the conditioning image encoder neural network has been pre-trained on a self-supervised learning task.

16. The method of claim 13, wherein the conditioning image encoder is configured to:
generate an input sequence of tokens from the conditioning image; and
generate an output sequence of tokens representing the conditioning image by processing the input sequence of tokens.

17. The method of claim 16, wherein the output sequence of tokens is the encoded representation of the conditioning image.

18. The method of claim 12, wherein the image generation neural network comprises an attention layer configured to apply an attention mechanism to (i) a representation of the output image and (ii) the encoded representation.

19. The method of claim 18, wherein the attention mechanism is cross-attention between (i) the representation of the output image and (ii) the encoded representation.

20. The method of claim 18, wherein the attention mechanism is self-attention over (i) the representation of the output image and (ii) the encoded representation.

21. The method of claim 2, wherein the one or more image generation tasks are not image-conditional generation tasks.

22. The method of claim 1, wherein each training example further comprises a second training conditioning image and wherein the image generation neural network is configured to generate the output image conditioned on the conditioning image and a second conditioning image.

23. The method of claim 1, wherein each training example further comprises a training conditioning text sequence and wherein the image generation neural network is configured to generate the output image conditioned on the conditioning image and a conditioning text sequence.

24. The method of claim 1, wherein each training conditioning image is a composite of two or more original conditioning images.

25. The method of claim 1, further comprising:
after the training:
receiving a new conditioning image; and
processing the new conditioning image using the image generation neural network to generate a new output image that is semantically similar to the new conditioning image.

26. The method of claim 25, further comprising:
training another image generation neural network on a new training data set that includes the new output image.

27. The method of claim 25, further comprising:
using the new output image and the new conditioning image to evaluate an image encoder neural network.

28. A system comprising one or more computers and one or more storage devices storing instructions that are operable, when executed by the one or more computers, to cause the one or more computers to perform operations, the operations comprising:
obtaining a training data set comprising a plurality of training examples, each training example comprising:
(i) a training conditioning image, and
(ii) a training target image that has been identified as being semantically similar to the training conditioning image; and
training, on the training data set, an image generation neural network that is configured to generate an output image conditioned on a conditioning image.

29. One or more computer storage media encoded with instructions that, when executed by one or more computers, cause the one or more computers to perform operations, the operations comprising:
obtaining a training data set comprising a plurality of training examples, each training example comprising:
(i) a training conditioning image, and
(ii) a training target image that has been identified as being semantically similar to the training conditioning image; and
training, on the training data set, an image generation neural network that is configured to generate an output image conditioned on a conditioning image.

30. A method performed by one or more computers, the method comprising:
receiving a new conditioning image; and
processing the new conditioning image using an image generation neural network to generate a new output image that is semantically similar to the new conditioning image, wherein the image generation neural network has been trained on a training data set comprising a plurality of training examples, each training example comprising:
(i) a training conditioning image, and
(ii) a training target image that has been identified as being semantically similar to the training conditioning image.
